(19) United States
(12) Patent Application Publication
(10) Pub. No.: US 2026/0097518 A1
(43) Pub. Date: Apr. 9, 2026

(54) ROBOTIC KITCHEN SCHEDULING SYSTEM FOR COOKING MULTIPLE FOOD ITEMS IN PARALLEL IN A COMMERCIAL KITCHEN AND RELATED METHODS

(71) Applicant: Miso Robotics, Inc., Pasadena, CA (US)

(72) Inventors: Nicholas Ardavin, Los Angeles, CA (US); Zachary Zweig Vinegar, Pasadena, CA (US); Bachir Kharraja, Irvine, CA (US)

(21) Appl. No.: 19/344,066

(22) Filed: Sep. 29, 2025

Related U.S. Application Data
(60) Provisional application No. 63/703,953, filed on Oct. 5, 2024.
(60) Provisional application No. 63/728,067, filed on Dec. 4, 2024.

(51) Int. Cl. B25J 11/00; A47J 37/12; B25J 15/00; B25J 19/02

(52) U.S. Cl. CPC B25J 11/0045; A47J 37/1219; A47J 37/1228; A47J 37/1266; B25J 15/0019; B25J 19/023

(57) ABSTRACT

An automated food preparation system includes a robotic arm and a plurality of functional stations for dispensing raw food to a bin, transferring the raw food from the bin to a fry basket, frying the raw food, and transferring the cooked food to a receiving pan. The system is programmed and operable to receive multiple orders, and compute a schedule based on applying a set of heuristic rules, and if more than one option is available for a food preparation step, to simulate the options and apply the option that would result in reducing overcooking lateness. Related methods are described.

### CROSS-REFERENCE TO RELATED APPLICATIONS

This claims priority to application No. 63/728,067, filed Dec. 4, 2024, and entitled “ROBOTIC KITCHEN SCHEDULING SYSTEM FOR COOKING MULTIPLE FOOD ITEMS IN PARALLEL IN A COMMERCIAL KITCHEN AND RELATED METHODS”; and to application No. 63/703,953, filed Oct. 5, 2024, and entitled “AUTOMATED FOOD FRYING SYSTEM” each of which is incorporated herein by reference in its entirety for all purposes.

### BACKGROUND OF THE INVENTION

### 1. Field of the Invention

This invention relates to food preparation systems, and more particularly, to automated food preparation systems adapted to provide freshly fried food items without human interaction.

### 2. Description of Related Art

Robotic kitchen systems are designed to operate automatically, continuously, up to 24 hours a day. During busy conditions, multiple orders can stress available resources in the kitchen leading to undercooking, overcooking or serving food cold. Overcooking lateness is a particular problem. Overcooking lateness may occur because the robot kitchen assistant is occupied performing another action, and cannot return the cooked food. Cooked food must be discarded and orders repeated if the overcooking lateness is too high. As used herein, “overcooking lateness” refers to the amount of time a food item remains cooking beyond its maximum designated cook time.

Scheduling has been performed by humans based on a sense of prioritizing and timing the cooking steps. However, humans can be naturally prone to some amount of error, which increases in incidence and perhaps consequence, during busier conditions or longer hours.

Another goal in cooking in the commercial environment is output, that is, to increase completed order output. Although humans have a sense of timing and operating steps in parallel, it is hard for a human to estimate multiple steps, orders, cooking times too far into the future.

Accordingly, there is a need for improved robotic systems that address the above-mentioned challenges.

### SUMMARY OF THE INVENTION

In embodiments of the invention, an automated food preparation system for cooking raw food comprises: an enclosure defining a robot workspace; a robotic arm and gripper arranged within the robot workspace; and a plurality of functional stations.

In embodiments, the plurality of functional stations comprises: a dispensing station for dispensing raw food into a basin within the enclosure; a food transfer station comprising the basin and arranged within the enclosure to receive the raw food from the dispensing station, and operable to lift the basin, and to transfer the raw food from the basin to a fry basket held by the gripper of the robotic arm; a fry station arranged within the enclosure and comprising at least one fryer slot for submerging a fry basket of raw food, and at least one unsubmerged hanger slot.

In embodiments, the system further comprises a computer comprising: a state manager module for maintaining the system state and a scheduling module.

In embodiments, the scheduling module is programmed and operable to: receive one or more orders for cooked food; compute a schedule to control actions of the plurality of functional stations to transfer the raw food to the fry basket, move the fry basket into a fryer slot and fry the raw food, move the fry basket into a hanger slot, dump the cooked food to an egress area for transferring the cooked food from inside the enclosure to outside the enclosure; send the schedule to each of the plurality of functional stations for execution.

In embodiments, the scheduling module computes the schedule by applying a set predetermined heuristic rules. Where more than one option exists for determining an action, the scheduling module applies a predictor model to predict a cost for each option. The module then selects an optimal option corresponding to reducing the cost. Then, the scheduling module converts a simulated system state event history into the schedule.

In embodiments, the cost is overcooking lateness, and optionally, a weighted sum of overcooking lateness for multiple individual orders.

In embodiments, the predetermined heuristic rules are applied for scheduling actions for transferring raw food to the fry basket from the elevator basin; actions for a basket of cooked food; and actions for a basket of uncooked food.

In embodiments, the predictor model comprises the following steps: computing overcooking lateness for a set of predetermined default actions (t_{c}); computing overcooking lateness for each alternative option (t1, t2, t3, . . . tn); and selecting for the schedule a behavior or sequence of behaviors from the set of predetermined default actions or the alternative option having the least overcooking lateness.

In embodiments, the predictor model is applied when the system state comprises: robot arm gripper has an empty basket; and when the robot arm gripper is not holding a basket, and optionally only when the system state comprises: robot arm gripper has an empty basket; and when the robot arm gripper is not holding a basket.

In embodiments, the system further comprises an auto-drawer station arranged within the enclosure comprising at least one drawer movable from a retracted first configuration within the enclosure to an extended second configuration through an ingress window outside of the enclosure, and wherein the at least one drawer and ingress window are arranged, sized and operable to transfer a fry basket between a human outside of the enclosure and the robotic arm inside of the enclosure without the human or robotic arm penetrating a boundary defined by the enclosure.

In embodiments, the system further comprises a light curtain or another safety system to detect when the drawer is in the second configuration or when the ingress window is penetrated by an object.

In embodiments, the system further comprises at least one camera arranged to obtain image data of any contents in the fry basket in the retracted configuration, when the drawer is closed.

In embodiments, the computer system is further programmed and operable to detect and classify a food item based on the image data, and wherein the computer system is programmed and operable to generate an order based on the food item classified from the perception module.

In embodiments of the invention, a method for automatically cooking raw food comprises: receiving one or more orders; computing a schedule to control actions of a plurality of functional stations to transfer the raw food to a fry basket, move the fry basket into a fryer slot and fry the raw food, move the fry basket into a hanger slot, dump the cooked food to an egress area; and sending the schedule to each of the plurality of functional stations for execution.

In embodiments, the step of computing a schedule comprises: applying a set of predetermined heuristic rules; determining whether more than one option exists based on a simulated system state, and where more than one option exists, predicting a cost for each option, selecting an optimal option corresponding to reducing the cost; and converting a simulated system state event history into the schedule.

In embodiments, the cost is overcooking lateness, and optionally, a weighted sum of overcooking lateness for multiple individual orders.

In embodiments, the predetermined heuristic rules are applied for scheduling: actions for transferring raw food to the fry basket from the elevator basin; actions for a basket of cooked food; and actions for a basket of uncooked food.

In embodiments, the predicting comprises the following steps: computing overcooking lateness for a set of predetermined default actions (t_{c}); and computing overcooking lateness for each alternative option (t1, t2, t3, . . . tn).

In embodiments, the selecting comprises selecting the set of predetermined default actions or the alternative option having the least overcooking lateness.

In embodiments, the predicting is applied when the system state comprises: robot arm gripper has an empty basket; and when the robot arm gripper is not holding a basket, and optionally, only when the system state comprises: robot arm gripper has an empty basket; and when the robot arm gripper is not holding a basket.

In embodiments, the method further comprises obtaining image data of any contents in the fry basket in a drawer of an auto-drawer station when the drawer is in a retracted configuration.

In embodiments, the method further comprises detecting and classifying a food item in the drawer based on the image data, and generating an order based on the classified food item.

In another embodiment of the invention, a non-transitory machine-readable medium, comprising executable instructions that, when executed by a processing system including a processor, facilitate performance of robotic kitchen cooking operations, the operations comprising: receiving one or more orders; computing a schedule to control actions of a plurality of functional stations to transfer raw food to a fry basket; moving the fry basket into a fryer slot and fry the raw food, moving the fry basket into a hanger slot, dumping the cooked food to an egress area; and sending the schedule to each of the plurality of functional stations for execution.

In embodiments, the schedule computing comprises: automatically applying a predetermined heuristic rule-driven action based on a simulated system state; determining whether more than one action exists based on the simulated system state, and where more than one action exists, predicting a cost for each action, and applying an optimal action corresponding to minimizing the cost; updating the simulated system state based on the actions applied and recording updated simulated system state in a simulated system event history; and converting the simulated system state event history into the schedule.

In another embodiment of the invention, a method for automatically cooking raw food comprises: receiving one or more orders; updating the actual system state based on the received orders; computing a schedule to control actions of a plurality of functional stations; and sending the schedule to each of the plurality of functional stations for execution.

In embodiments, the schedule computing comprises: creating a simulated system state; determining whether more than one option exists based on the simulated system state, and where more than one option exists, predicting a cost for each option, and selecting an optimal option corresponding to reducing the cost; updating the simulated system state based on the optimal option; and converting a simulated system state event history into the schedule.

In embodiments, a non-transitory machine-readable medium, comprising executable instructions that, when executed by a processing system including a processor, facilitate performance of robotic kitchen cooking operations, the operations comprising: receiving one or more orders; computing a schedule to control actions of a plurality of functional stations to transfer raw food to a fry basket, move the fry basket into a fryer slot and fry the raw food, move the fry basket into a hanger slot, and dump the cooked food to an egress area; sending the schedule to each of the plurality of functional stations for execution. In embodiments, the computing a schedule comprises: automatically applying a predetermined heuristic rule-driven action based on a simulated system state; determining whether more than one action exists based on the simulated system state, and where more than one action exists, predicting a cost for each action, and applying an optimal action corresponding to minimizing the cost; updating the simulated system state based on the actions applied and recording updated simulated system state in a simulated system event history; and converting the simulated system state event history into the schedule.

The description, objects and advantages of the present invention will become apparent from the detailed description to follow, together with the accompanying drawings.

### BRIEF DESCRIPTION OF THE DRAWINGS

FIG. 1 illustrates a left-side top isometric view of a robotic food preparation system in accordance with an embodiment of the invention;

FIG. 2 is a front view of the robotic food preparation system shown in FIG. 1;

FIG. 3 is a top view of the robotic food preparation system shown in FIG. 1;

FIG. 4 is a flow chart of an overview of method for cooking using a robotic food preparation system in accordance with an embodiment of the invention;

FIG. 5 is flow chart of a method for computing a schedule using a robotic food preparation system in accordance with embodiments of the invention;

FIG. 6 is flow chart of an elevator planning sub-process using a robotic food preparation system in accordance with embodiments of the invention;

FIG. 7 is flow chart of an empty gripper planning sub-process using a robotic food preparation system in accordance with embodiments of the invention;

FIG. 8 is flow chart of an empty basket planning sub-process using a robotic food preparation system in accordance with embodiments of the invention;

FIG. 9 is flow chart of a full basket of cooked food planning sub-process using a robotic food preparation system in accordance with embodiments of the invention;

FIG. 10 is flow chart of a full basket of uncooked food planning sub-process using a robotic food preparation system in accordance with embodiments of the invention;

FIG. 11 is flow chart of an overview of a scheduling method using a robotic food preparation system in accordance with embodiments of the invention;

FIG. 12 is flow chart of an overcooking lateness predictor module using a robotic food preparation system in accordance with embodiments of the invention; and

FIG. 13 is a block diagram of a robotic scheduling and food preparation system in accordance with embodiments of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### Apparatus Overview

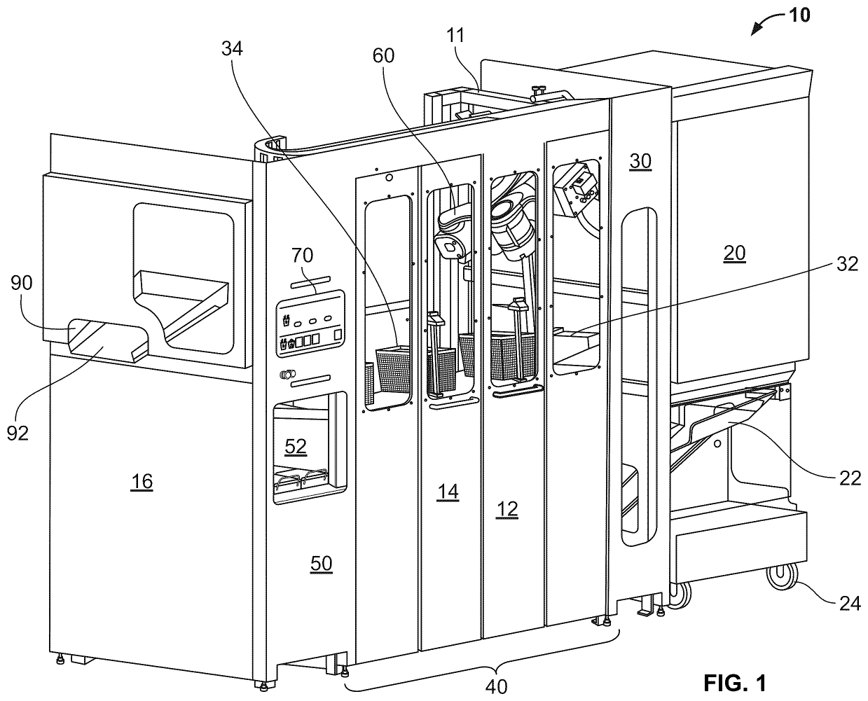

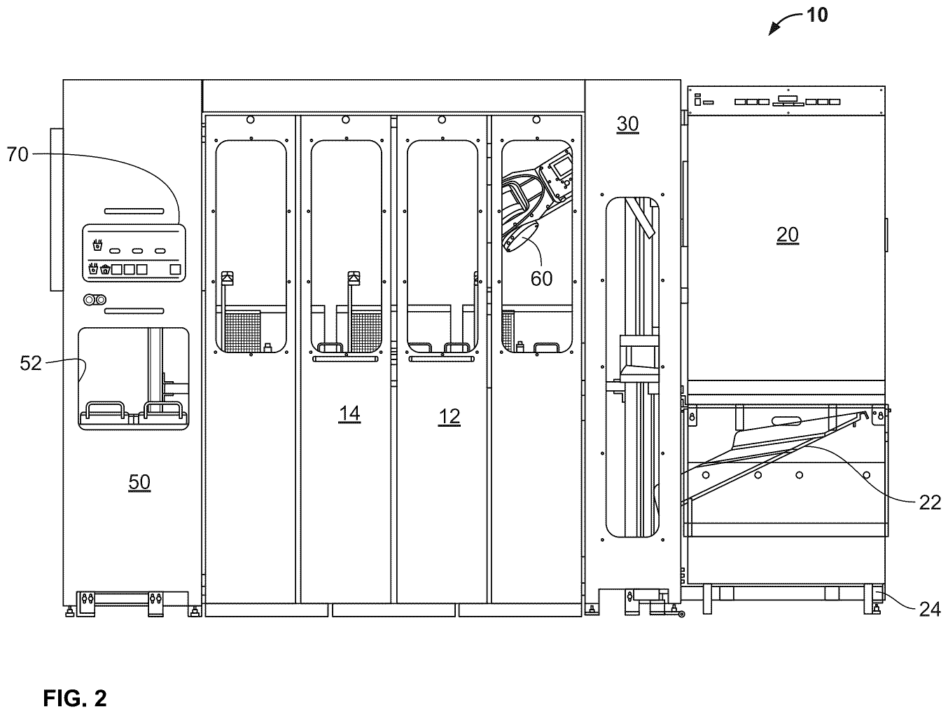

FIGS. 1-3 show various views of an automated food preparation system 10 for frying raw food in accordance with an embodiment of the invention. Non-limiting examples of types of raw foods for frying include tortilla chips, fries, popcorn chicken, chicken nuggets or wings, fish sticks, and vegetables.

The system 10 is shown having several functional stations or modules including a refrigerated food dispenser/hopper 20, a raw food transfer station 30 (including elevator basin 32), fryer station 40 (including fryers 42, 44, 46), fry baskets 34, auto-basket station 50 (including raw food ingress window 52), robotic arm 60, touchscreen user interface 70, and cooked food egress window 90 (including chute 92), each of which is discussed herein.

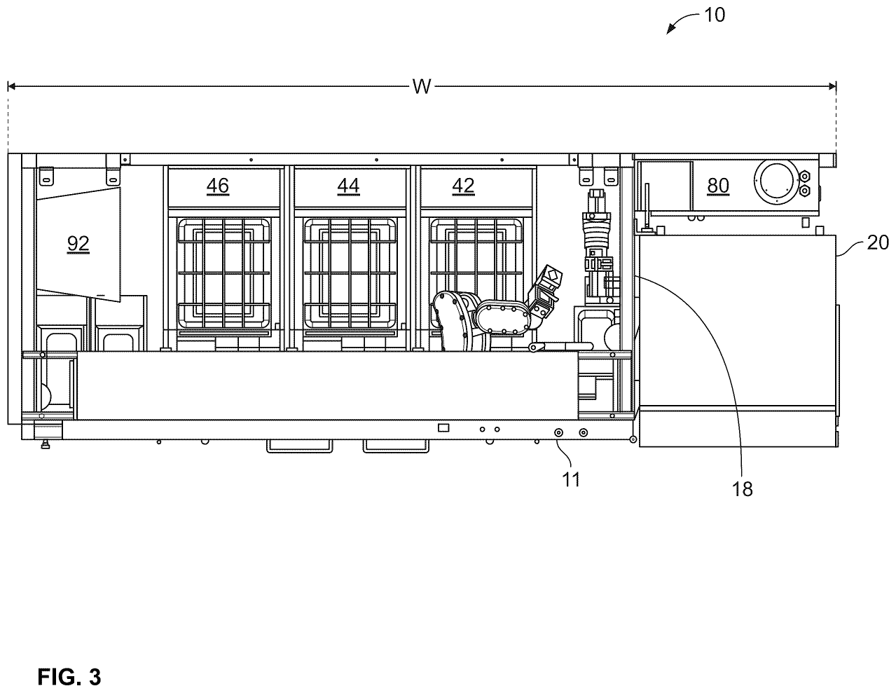

Functional stations 30, 40, and 50 are shown arranged within an enclosure, thereby defining a robotic workspace that separates the robotic arm 60 from a human or operator. The enclosed or walled robotic workspace is shown having a frame 11, front doors 12, 14, left side wall 16, and right-side wall 18. With reference to FIG. 3, the dispenser 20 is located in a square space defined by the right-side wall 18 of the enclosure and the electronic box assembly 80. Optionally, a sensor (e.g., a magnetic proximity sensor) is arranged on the frame or electronic box assembly to confirm proper location of the dispenser 20 relative to the frame and enclosed robotic workspace. Optionally, the dispenser 20 includes castors 24 for adjusting its location relative to the robotic enclosure.

Additionally, electronic and computer components, discussed herein, can be enclosed within an electronics housing or enclosure 80 and mounted to the frame 11 for controlling the various stations and collecting and storing data.

One or more sensors and cameras can be arranged with the enclosure and stations. The image data is sent to the computer and electronics. As discussed further herein, in embodiments, the sensed data and images can be used to detect and track various objects including, e.g., amount of food dispensed, type and amount of food placed in a basket of a drawer, elevator position, basket location, state of an order, robotic workspace (e.g., door or drawer) open, as discussed further herein.

An example of a robotic food preparation system including the various functional stations is described in provisional patent application No. 63/703,953, filed Oct. 5, 2024, entitled “AUTOMATED FOOD FRYING SYSTEM”, which is incorporated herein by reference in its entirety for all purposes.

### Food Dispenser

In embodiments, and with reference to FIGS. 1-3, the dispenser station 20 dispenses a predetermined amount of raw food into a bin. An example of a suitable refrigerated food dispenser is the RAM 280, manufactured by Taylor UK (Ipswich, England). In embodiments, the dispenser is operable to be programmed to dispense a predetermined (or target) amount of food.

### Elevator Station

In embodiments, the motorized elevator station 30 automatically lifts the bin above a fry basket, and dumps the raw food into the fry basket 34. The elevator station can include a motor and linear guide assembly for moving the bin along the guide. In embodiments, the bin is operable to dump the raw food to the fry basket by, e.g., (a) tilting or (b) opening a trap door, thereby releasing the contents. An example of an elevator station is described in provisional patent application No. 63/703,953, filed Oct. 5, 2024, entitled “AUTOMATED FOOD FRYING SYSTEM”, which is incorporated herein by reference in its entirety for all purposes.

### Robotic Arm Assembly

In embodiments, the robotic arm assembly 60 is operable to grip and move the fry basket into the fryer 42, 44, 46 for cooking.

After the food is cooked, the robotic arm removes the fry basket from the fryer and dumps the cooked food onto a chute 92. The chute gravity feeds the cooked food into a hot hold for pickup.

An exemplary robotic arm 60 has 6-axis motion (or degrees of freedom) such as the Yaskawa GP4 Arm manufactured by Yaskawa America, Inc., Motoman Robotics Division (Miamisburg, OH).

Additionally, in embodiments, the robotic arm assembly includes a gripper for gripping a handle of the basket 34, or for gripping an adapter fastened to the basket or another utensil. In embodiments, the gripper is a clamp-type assembly. An exemplary gripper is Zimmer Group GEP2016IO-05-B Gripper manufactured by Zimmer Group US Inc. (Hickory, NC). Examples of end effector clamping assemblies, holds and fry baskets are described in: U.S. Pat. No. 11,167,421, filed Aug. 7, 2019, entitled “ROBOTIC KITCHEN ASSISTANT INCLUDING UNIVERSAL UTENSIL GRIPPING ASSEMBLY”; U.S. Pat. No. 11,192,258, filed Aug. 7, 2019, entitled “ROBOTIC KITCHEN ASSISTANT FOR FRYING INCLUDING AGITATOR ASSEMBLY FOR SHAKING UTENSIL”, and US Publication No. 20230292957, filed Jan. 31, 2023, entitled “AUTOMATED FOOD FRYING SYSTEM”, each of which is incorporated herein by reference in its entirety.

In embodiments, the robotic arm and gripper execute a predetermined route. The 3D coordinates of the predetermined routes can be manually executed and saved. In embodiments, after the gripper clamps onto the fry basket, the robotic arm moves the fry basket from the elevator into the fryer along a predetermined 3D route according to a predetermined velocity. A library of predetermined routes can be stored for the robotic arm for each type of order, or activity (e.g., cleaning, calibration, frying, dumping, home, etc.).

### Fryer

Fryer station 40 is shown including three (3) fryers 42, 44, and 46. Each fryer includes at least one slot to hold a fry basket in the oil in a submerged state and one slot to hold a fry basket above the oil in an unsubmerged state.

### Auto-Basket Station

Optionally, an auto-basket station 50 is operable to accept baskets and alternative types of raw food for cooking.

Indeed, a wide variety of food preparation actions can be performed by the robotic food preparation system. The invention is not intended to be limited to any particular configuration except as recited by the claims.

### Method Overview

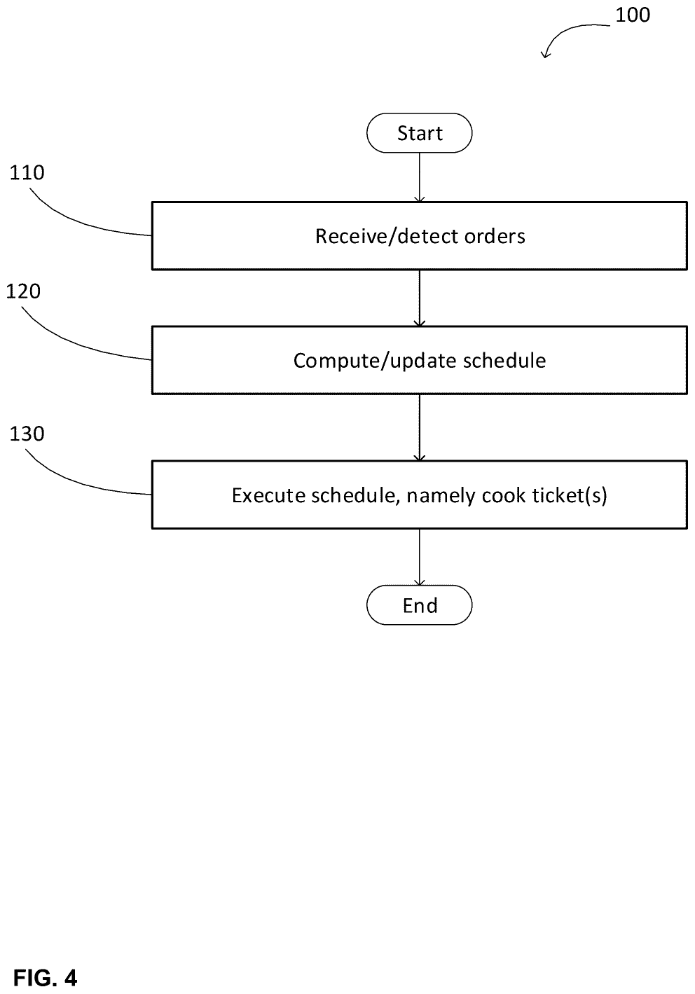

FIG. 4 shows a flow chart of an overview of a method 100 for cooking using a robotic food preparation system in accordance with an embodiment of the invention.

Step 110 states to receive/detect orders. In embodiments, this step may be performed by a processor receiving a user order via a computer, kiosk or UI. For example, in embodiments, a button on the UI 90 is operable to trigger a service call to a system state manager, which creates the ticket in the system state.

Additionally, an order may be created based on detecting and classifying a type of food placed in an auto-basket drawer. For example, when a food is placed in a fry basket and placed in one of the auto-baskets of the auto-drawer state 50, a perception system will indicate to the state manager that there is a basket in one of the auto-basket slots, and food type in that basket. That will trigger the state manager to create a ticket for the food.

If the perception module computes a confidence level above a predetermined threshold value (e.g., above 0.9) in the food type, it will create the ticket automatically. If it is not, it will create an “unclassified” ticket, which would trigger the UI to prompt the user to manually classify the food via the UI by selecting a food type from a list of options. Once the user classifies the food type, the corresponding ticket will be marked as classified and available to cook.

Step 120 states to compute/update schedule. As discussed herein, a scheduling module is programmed and operable to automatically compute a list of actions or behaviors (namely, automatic motions) and start times that the robot shall execute. For embodiments, the list of computed behaviors for each agent (e.g., a motion of the robotic arm) are strictly ordered in increasing time. However, multiple behaviors for different agents may be scheduled to happen in parallel. For embodiments, a possible schedule of behaviors for the robot arm is without limitation:
Move from home to fryer slot 1, starting at time T1;
Unsubmerge with 4 agitations, 2 oil drips in fryer slot 1, starting at time T2 (in embodiments, by ‘oil drip’, it is meant the number of up-and-down cycles the arm is moved above the fryer);
Move from fryer slot 1 to auto-basket handoff waypoint, starting at time T3;
Dropoff basket in auto-basket handoff 2, starting at T4;
. . . ; and
Move to home, starting at T20

For embodiments, the possible schedule of behaviors for the elevator/dispenser agent includes without limitation:
Fetch small order from dispenser left side, Starting at T3;
Dump order from elevator bin, Starting at T6;
. . . ; and
Put elevator in sleep mode, starting at T18.

The computed schedules can be used in different ways.

For embodiments, the schedule can be used by the agent managers to actually execute the behaviors in the schedule. Each agent is listening to the schedule, and when it is not already executing a behavior, it checks the first behavior listed for itself in the newest schedule. If the desired start time in the schedule is <=the current time, the agent will begin executing that behavior.

For embodiments, as discussed further herein, the schedule can be used to predict the future state of the system. In embodiments, as discussed herein, the computed schedule can be used to simulate actions on top of a given state to see how the state will be affected.

For example, the schedule can be used to predict when orders will be returned (or served) to the customer. In embodiments, this is performed by summing the time to complete each individual step to complete the order. More specifically, in embodiments, starting from the current system state, the entire schedule is applied in sequence, and then all the orders are examined in the simulated final state to find the time they shall be returned to the user. This is the predicted time which can then be displayed to the user.

In alternative embodiments, a portion of the schedule is applied to ‘see’ the system state at a particular time in the future. For example, the first 30 seconds of the scheduled behaviors are applied to answer a question such as “Will an empty basket be returned to the auto-basket drawers in the next 30 seconds?” The simulated system state may be reviewed at the simulated 30 second time point for the information.

Indeed, the computed schedule may be utilized in a wide variety of ways except where excluded from any of the appended claims.

Step 130 states to execute schedule, namely, cook tickets. Indeed, now that the schedule from step 120 is generated or updated, each of the robotic agent managers (e.g., the robotic arm or elevator/dispenser managers) receive the schedule and carry out its instructions.

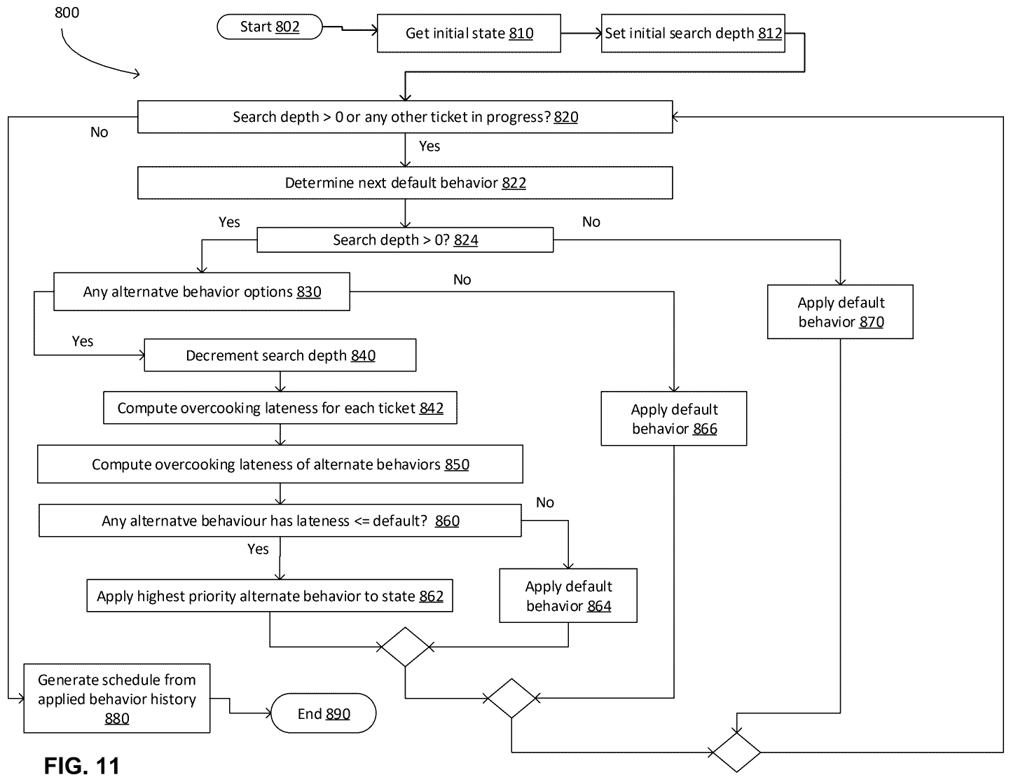

FIG. 11 is a flow chart of an overview of a scheduling method 800 for computing a schedule for a robotic kitchen system when there are alternate robotic behaviors available during cooking, according to embodiments of the invention.

Step 802 is the start of the process.

Step 810 states to get initial state. This step is performed as described herein. The system state is obtained from the state manager.

Step 812 states to set initial search depth. This step is performed as described herein. The system search depth is set to limit the number of iterations. In embodiments, the search depth or counter is initially set to greater than 1, and sometimes between 1 and 10, and sometimes about 3-5.

Step 820 is directed to determining whether to attempt to schedule any cooking actions, or if the cooking portion of the schedule is complete. In embodiments, this step is performed by querying whether the search depth is greater than 0, or any ticket is in progress. Assuming the search depth is greater than 0 for the first iteration, the method proceeds to step 822.

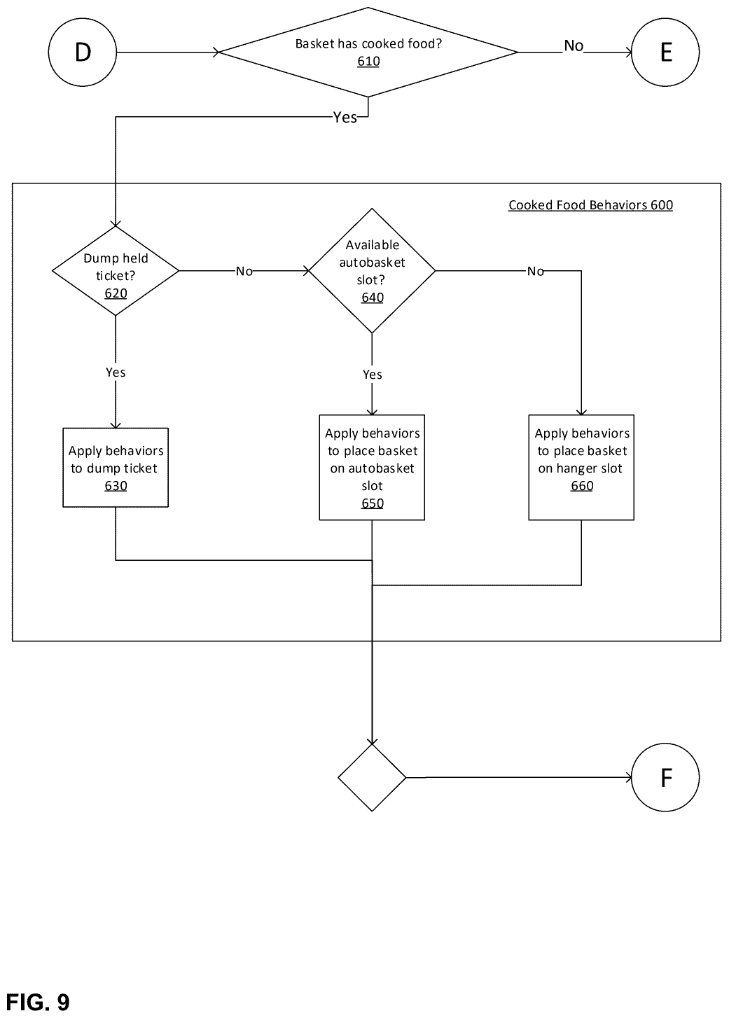

Step 822 states to determine the next default behavior. In embodiments, the next default behavior (for the robotic arm or elevator) is dictated by the heuristic rules described herein and based on the system state. For example, if there is a basket of cooked food, the default behaviors are set forth as described herein with reference to FIG. 9. In embodiments, the “default behavior” is generally the behavior(s) to advance cooking on all in-progress tickets in order to minimize overcooking. The default actions are dictated based on the system state and heuristic rules. There are no options to simulate and evaluate. The output of step 822 is the default action(s) for the robot or a set of actions or steps for the robot to perform.

Step 824 queries whether the search depth is greater than 0. For example, if a ticket is in-progress, and the search depth is not greater than the threshold value (e.g., 0), the method proceeds to step 870 which states to apply the default behavior to the simulated state as determined above in Step 822. The system state is updated in accordance with the default action for the robot as determined in step 822.

If the search depth is greater than the threshold value at step 824, however, the method proceeds to step 830.

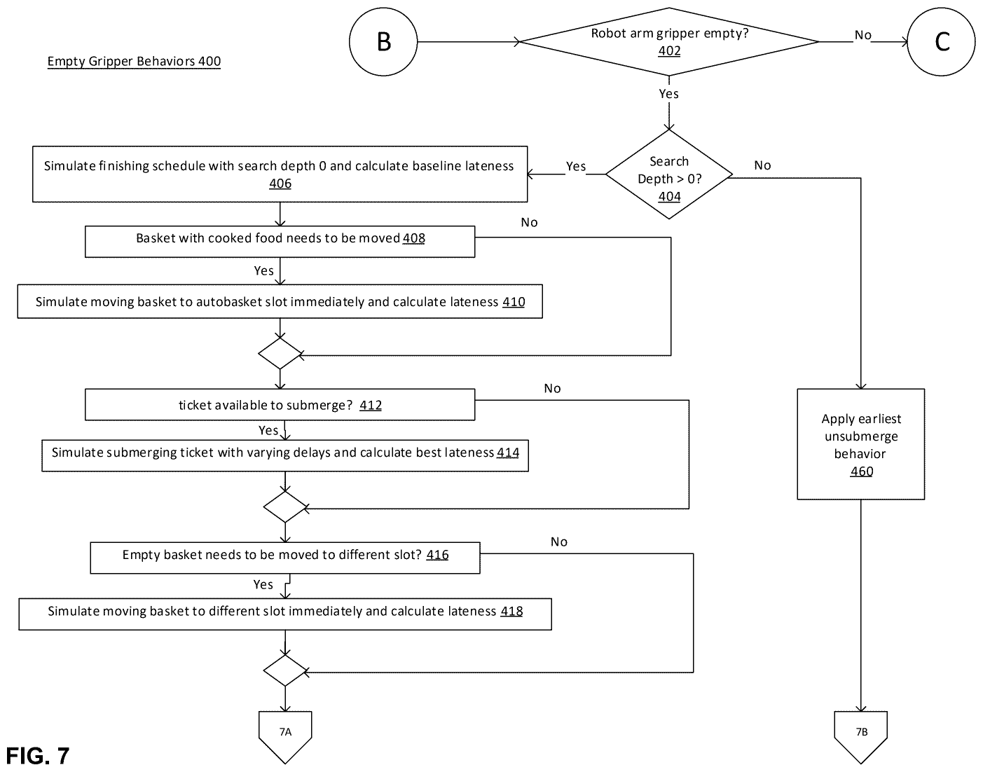

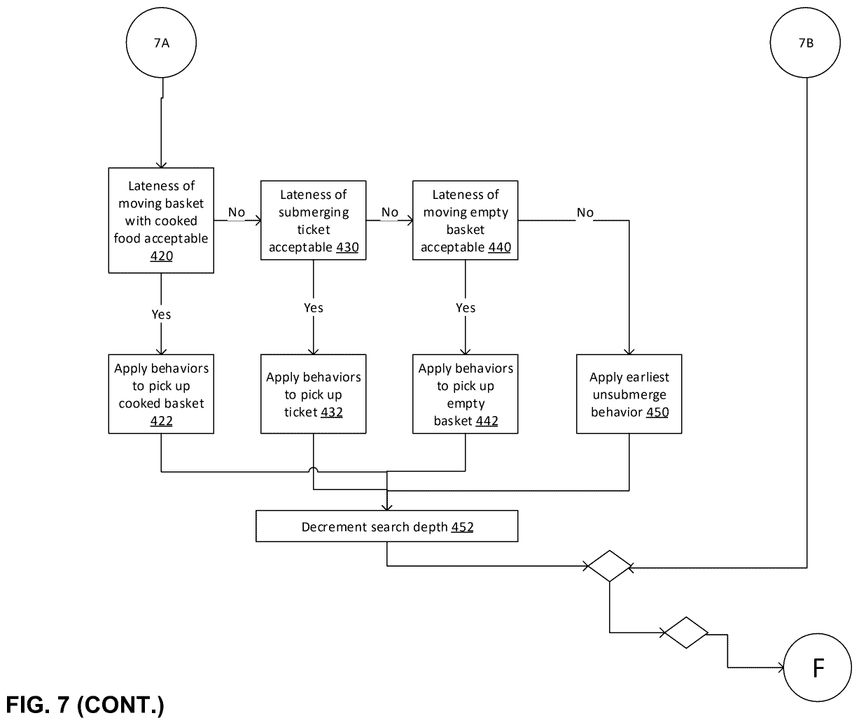

Step 830 states to determine alternate behavior options. For example, if the simulated system state is ‘empty gripper’, there are several optional robot actions to choose from as described herein with reference to FIG. 7.

If there are no additional behavior options besides the default action(s), the method proceeds to step 866, in which case the default behavior identified above is applied to the simulated system state. The search depth is not reduced in cases without alternate behavior options.

If, however, an option is available, the method proceeds to step 840.

Step 840 states to decrement search depth. This step can be performed by subtracting one (1) from the current search depth.

Step 842 states to compute overcooking lateness of default.

In embodiments, by ‘overcooking lateness’, it is meant the duration the ticket has cooked beyond its maximum cook time. In embodiments, by ‘total overcooking lateness’ it is meant the sum of the duration each ticket has cooked beyond its maximum cook time multiplied by the ticket's priority, multiplied by the ticket's priority.

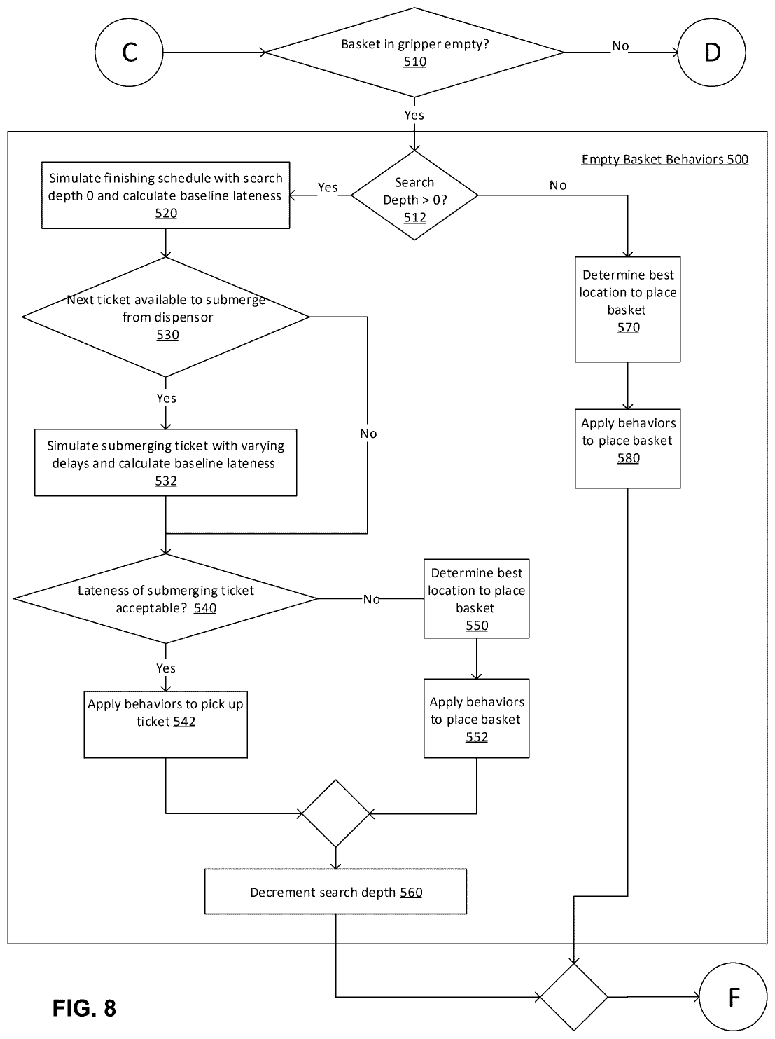

This step can be performed, e.g., as described herein with reference to steps 406, 520 in FIGS. 7 and 8, respectively.

Step 850 states to compute overcooking lateness of alternative behaviors. This step can be performed, e.g., as described herein with reference to steps 410, 414, 418 in FIG. 7.

Step 860 queries whether any of the alternate behaviors have a computed lateness less than or equal to the computed control or default lateness. If ‘yes’, the method proceeds to step 862.

Step 862 states to apply the highest priority alternate behavior to the state. In embodiments, each behavior is ranked by priority based on the value in progressing cooking workflows. For embodiments, returning a basket with cooked food to the user has a higher priority (e.g., level 1) than returning an empty basket to the user (e.g., level 2). Step 862 applies the optional behavior with the highest priority that results in a lateness less than or equal to the baseline to the state.

If at step 860, however, no alternate behavior has a lateness less than the default lateness, the method proceeds to step 864.

Step 864 states to apply the default behavior to the state. This step may be performed as described herein in connection with step 866.

Whether from step 862, 864, 866, or 870, the method returns to step 820 and the entire process described above is repeated until the search depth is not greater than 0, nor any ticket is in progress at which point the method advances to step 880.

Step 880 states to generate a schedule from the applied behavior history. This step is performed by the scheduler module and published on the historical simulated system state. The schedule is published or sent to the UI module and the agent module to carry out the actions, namely cook or fry the food.

Step 890 is the end of the process.

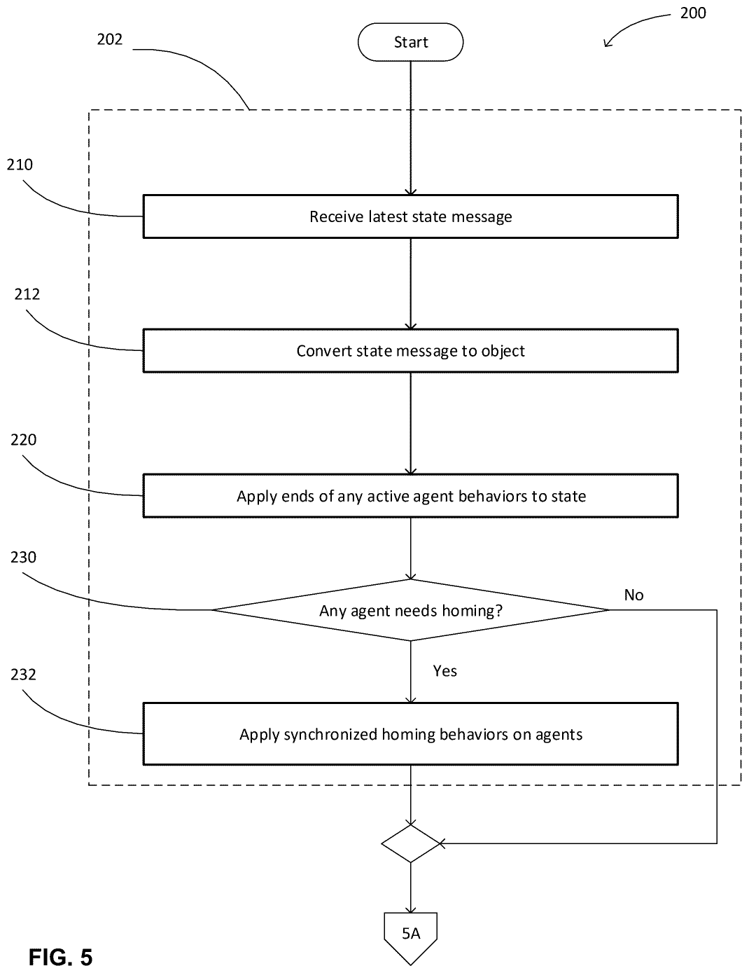

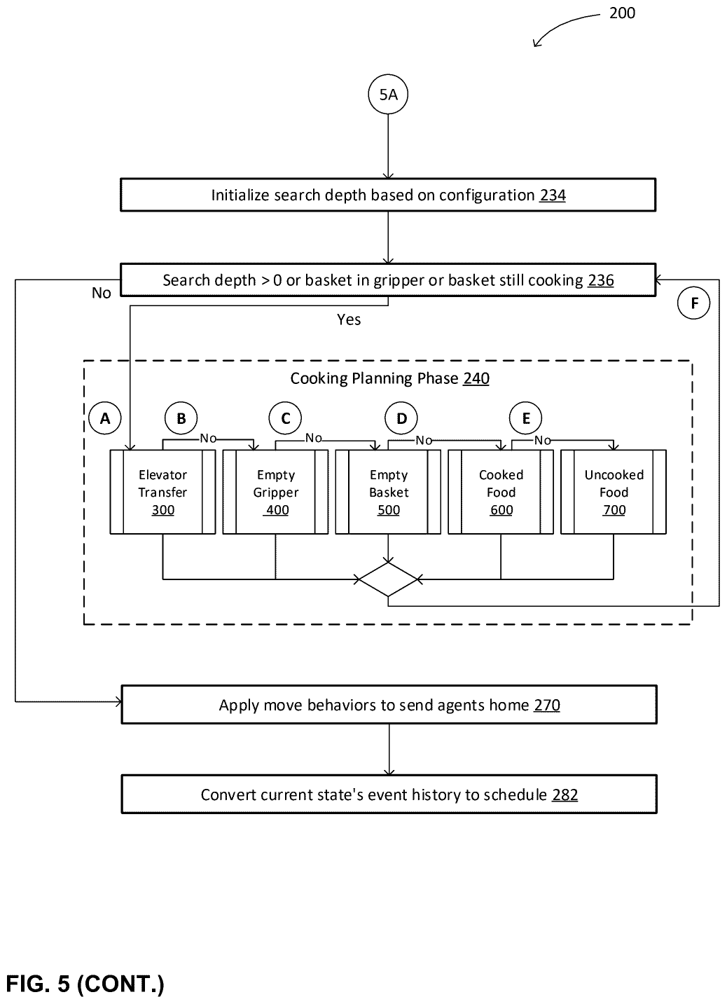

FIG. 5 is a more detailed flow chart of a method 200 for computing the schedule for a robotic food preparation system in accordance with an embodiment of the invention.

The method 200 is shown generally including three phases: an initialization phase 202, a cooking planning phase 240, and a cleanup-type phase 268. The output is a schedule including a set of computed actions (or behaviors) and times for the robotic food preparation system to perform.

The initiation phase 202 captures the most recent state message 210, and converts it to a state object 212. The state message 210 stores the key mutable properties of the system state. Examples of the state's mutable properties include, without limitation:
Slots—Locations that a basket can reside in the system and whether the robot is allowed to use the slot;
Baskets—Location of the basket, such as the ID of a slot (or unknown), whether the robot is allowed to use the basket, and whether the basket currently has a lid;
Tickets—Food type, Portion size, Doneness level, return strategy (how the robot is allowed to return the cooked order to the user), Priority, Ticket location (such as the ID of a basket or ID of a non-basket container such as the dispenser), Event history of the ticket (including Order creation time, submerge time, Unsubmerged time, and Return time);
Agents—Independently controllable components of the robot system (such as robot arm, or elevator) including: whether the robot is allowed to control the agent, currently active behavior, if any, Pose of the agent, and agent-specific properties.

In addition, there are several immutable properties of the system. For embodiments, immutable properties are stored in global configuration that are known to all system nodes as necessary. The mutable and immutable properties are used to construct the state object, discussed herein. Examples of immutable properties include without limitation:

Environment parameters including: Total number of fryer/hanger/auto-basket slots, assumed food types loaded in the dispenser, Available baskets, and whether each has a specialty insert;

Menu including: Minimum & maximum cook times for each food type, at each doneness level; Preferred cooking fryer slots for each food type; Priority multiplier for each food type; and Number of pre-cook agitations, post-cook agitations, oil drip count, and dump shake count for each food type;

Heuristic goals including, for example:
Scheduler search depth;
Target basket arrangement (target number of baskets retained, number of extra baskets
allowed in the system, target number of empty baskets in the drawers, etc.);
Buffer time to add to schedule to account for unexpected delays;
Thresholds for error handling (number of mis-grabs before a basket is ignored or an environment scan is triggered); and
Target head start for elevator to be ready before arm at the pre-transfer position.

In embodiments, the state message is represented either as a robotic operating system (ROS) message, or as an object. In embodiments, the ROS message contains de-duplicated data that is easily serializable for communicating the state between different ROS modules or nodes, discussed herein.

For embodiments, the state message represents the state with as little data as possible. Without intending to be bound to theory, the state message is represented with as little data as possible to minimize the data sent between nodes, and to reduce the potential for an “invalid” state message.

A de-duplicated state message is constructed by minimizing the redundant data in the representation of the state. For instance, the location of a basket is stored as a one-way link from basket to slot ID. Similarly, the location of a ticket is stored as a one-way link from ticket to container ID. Any properties of the state that can be inferred or computed from some combination of other properties are not necessarily included in the representation of the state message.

However, in embodiments, the state message is commonly processed as a state object. The state object is a more complex representation, adding methods to query relations and complex properties across various aspects of the state and mutate the state easily. The state object can be instantiated from a single state message and the static configuration, and can be serialized into a state message at any point.

For embodiments, the state object includes bidirectional links between tickets and baskets, and baskets and slots. There are many different queries and transforms we do on the state object. For some embodiments, links are created for tickets to quickly have a reference to the basket they are located in, or for a basket to have a reference to any tickets it is holding. For embodiments, crosslinks are created between baskets and slots.

For embodiments, as the state object is updated to move baskets and tickets around, the bidirectional links are also made consistent.

An example of a state message is:

```
  slots: [
    {path: “/slot/fryer/1”, <slot-specific data>},
    {path: “/slot/fryer/2”, <slot-specific data>},
    ...
    {path: “/slot/hanger/6”, <slot-specific data>},
  ],
  baskets: [
    {path: “/basket/50”, slot_path: “/slot/fryer/2”, <basket-specific data> },
    {path: “/basket/51”, slot_path: “/slot/hanger/4”, <basket-specific data>},
    ...
  ],
  tickets: [
    {uuid: “352ed151-3f98-43d2-a22e-241010eabdbf”, container_path: “/basket/50”,
<ticket-specific data>},
    {uuid: “7a56cd3e-44d5-48e9-8233-3bba9c13fa6d”, container_path:
“/elevator_bin/1”, <ticket-specific data>},
    ...
  ]
```

Next, step 220 states to apply ends of any active agent behaviors onto the state. In embodiments, the method simulates any in-progress behaviors and updates the state object with any changes these behaviors are expected to apply. For example, if the robotic arm is currently in-progress for a submerging behavior, step 220 updates the state object to reflect the expected state once that submerging behavior has been completed, including the new state of the ticket, position of the basket, and resting pose of the robot arm.

Step 230 queries whether the agent needs homing. For example, if the elevator position is unknown, the method proceeds to step 232 to command a homing behavior for the elevator. Namely, to home any agents that are not in a known position or otherwise ready to run regular behaviors. Step 232 ensures that collisions between agents are not possible even when their positions are unknown. If the elevator requires homing, for example, it is a prerequisite that the robot arm position is known and not in the way of the elevator's path of motion.

After the initialization homing step 232, the method proceeds to step 234 to initialize the search depth (namely, a counter) based on the configuration. The search depth or counter controls the number of permitted iterations or loops in the scheduling scheme, discussed herein. For configurations with multiple behavior options that require a lookahead search to determine the best choice (e.g., whether to start cooking a new order, or return a basket to the drawers, or unsubmerge an already-cooking order), it is preferable for the search depth to be set higher generally corresponding to how far into the future the user desires to look. In embodiments, the search depth is greater than 1, and in some embodiments, ranges from 1 to 10, and more typically ranges from 3 to 5.

Step 236 is generally directed to determining whether any cooking actions are required. This step is performed automatically by the system (or scheduling module) by evaluating the search depth and simulated system state. In the embodiment shown in FIG. 5, step 236 states to query whether the (a) search depth is greater than zero (0), (b) a basket is in the gripper, or (c) a basket is still cooking (also referred to herein as a submerged ticket).

If the answer is ‘no’, (which implies no more cooking steps are required to progress the cooking workflows), the method proceeds to the cleanup phase 268, discussed herein.

However, if the answer to step 236 is ‘yes’, then the cooking planning phase is commenced/continued. The cooking planning phase 240 is shown including several different agent planning modules: elevator transfer planning 300, empty gripper planning 400, empty basket planning 500, cooked food planning 600, and uncooked food planning 700.

In embodiments, as discussed herein, each planning module includes one or more agent behaviors to be computed or simulated. After a single module simulates and records its respective behaviors, the method returns to the in-progress check step 236. After all such cooking agent behaviors are simulated and recorded, step 236 will indicate ‘no’, and the method proceeds to the clean-up simulation phase 268.

For embodiments, the cleanup simulation phase resets each agent to a resting or home pose per step 270 once all other necessary actions have been added to the schedule. Stated another way, without applying the cleanup phase, the robotic arm would stop above the last fryer slot that it interacted with once cooking is complete. For embodiments, during the cleanup planning phase, the robotic arm is sent to a home position. This ensures that when the robot arm (e.g., robot arm 60 shown in FIG. 1) has no upcoming actions, it is sent to the home position. Similarly, in embodiments, during the cleanup planning phase, the elevator (e.g., basin 32 shown in FIG. 1) is sent to the bottom of the rail guide and the motor is disabled to preserve the motor's life when not in use.

Next, per step 282, the system generates the schedule for other nodes to consume or process. In embodiments, the schedule is generated by converting the state object's behavior history into a series of behaviors by each robot. In embodiments, the schedule is sent to the robotic arm manager, the elevator transfer manager, and the UI interface module, for example.

An example of a schedule for robotic arm is as follows:
Move from home to fryer slot 1, starting at time T1;
Unsubmerge with 4 agitations, 2 oil drips in fryer slot 1, starting at time T2;
Move from fryer slot 1 to auto-basket handoff waypoint, starting at time T3;
Dropoff basket in auto-basket handoff 2, starting at T4; . . . ; and
Move to home, starting at T20

An example of a schedule for the elevator/dispenser is as follows:
Fetch small order from dispenser left side, starting at T3;
Dump order from elevator bin, Starting at T6;
. . . ; and
Put elevator in sleep mode, starting at T18 (Cleanup behavior).

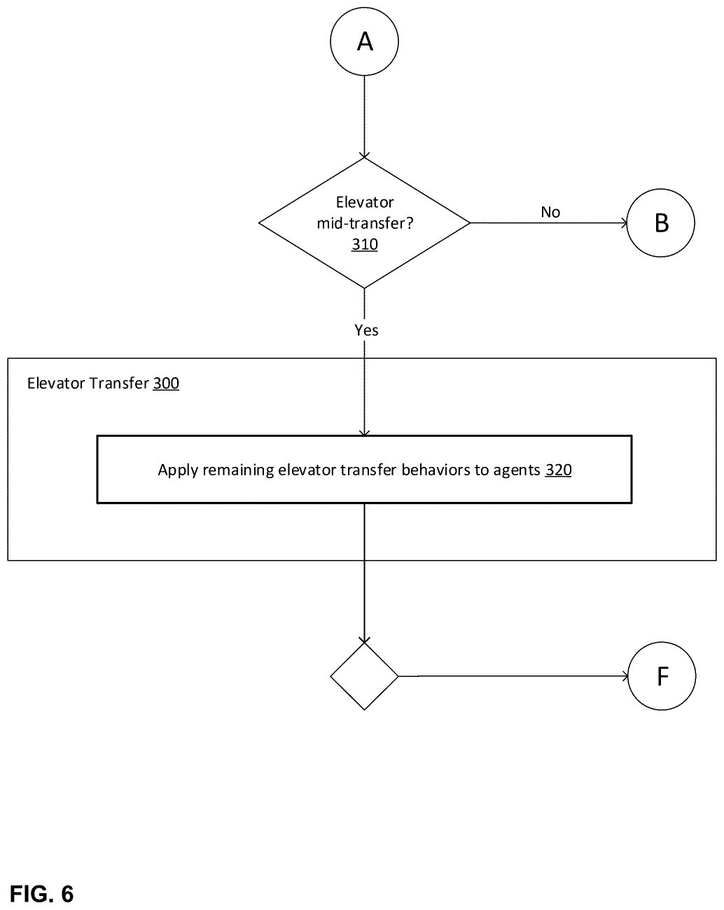

FIG. 6 is a flow chart of the elevator transfer planning module 300. In embodiments, per step 310, the computed or simulated system state is evaluated for whether the elevator is in the middle of transferring food to a basket held by the robot arm, i.e., the elevator is in the raised position, and the arm is underneath the elevator with a basket. In embodiments, these elevator transfer behaviors ensure the elevator opens the trap door to transfer food, and the robot arm departs from underneath the elevator. This interaction point between the two agents is handled in an explicit manner to ensure synchronization and avoid collisions between them. In embodiments, for all other cases, the elevator and robot arm are free to act in parallel, as they normally operate in their own zones.

If the elevator is not mid-transfer, the method proceeds to the next planning phase 400, discussed herein. However, if the elevator is mid-level or mid-transfer, the method proceeds to step 320 which states to apply remaining elevator transfer behaviors to the agents.

Step 320 states to apply remaining elevator transfer behaviors to agents. In embodiments, step 320 is performed by applying any unperformed steps from a set of pre-determined behaviors or commands for the elevator. Examples of steps for the elevator transfer to perform include, without limitation, opening the trap door to dump the food into a basket held by a robotic arm, and moving the robotic arm out from underneath the elevator. After all the elevator transfer behaviors are performed, and the simulated system state updated, with reference again to FIG. 5, the method returns to step 236 for querying whether the search depth is greater than zero, a basket is in the gripper, or the basket is empty.

FIG. 7 is a flow chart of the empty gripper planning module 400.

In embodiments, the empty gripper planning module 400 simulates various possible scenarios when the robotic arm is not currently holding any basket up to a threshold limit of times (namely, the search depth counter), and computes a cost for each scenario.

Examples of scenarios for the empty robot arm gripper to perform include: (a) unsubmerging the next ticket (namely, a fry basket of food) that has finished cooking, (b) moving a basket with cooked food from the hanger slot to an auto-basket slot, (c) submerging a new ticket, or (d) moving an empty basket to a more optimal slot. In embodiments, as described herein, the scheduler will use a predictor model to determine which option minimizes a cost.

In embodiments, the cost is total overcooking lateness. After the various potential scenarios are computed, the scheduler saves the choice with the minimal cost. In embodiments, lateness of a ticket is the duration that the ticket was cooked beyond the maximum cook time. In embodiments, the total lateness is the sum of all individual ticket latenesses, and optionally, each individual ticket lateness is weighted by a priority level prior to computing the sum. In embodiments, priority levels are pre-assigned to different actions, or in some embodiments, can be added to the ticket by the user.

In embodiments, an approach commences with step 402 which states to evaluate the simulated system state for whether the robot arm gripper is empty. For example, is the robot arm 60 as shown FIGS. 1-3 holding a basket according to the simulated system state.

If the robotic arm gripper is holding a basket according to the simulated system state, the method proceeds to the next phase 500, discussed herein. However, if the robotic arm gripper is not holding a basket according to the simulated system state, the method proceeds to step 404.

Step 404 queries whether the search depth counter is greater than a threshold value (e.g., zero ‘0’).

If the search depth is not greater than 0, the method proceeds to step 460 which states to apply the earliest unsubmerge behavior, if there are any tickets remaining in the fryers.

According to step 460, if there are any tickets remaining in the fryers, the earliest or first ticket is unsubmerged at the earliest possible time that does not result in undercooking. An example of this earliest unsubmerge behavior sequence by the system includes, without limitation, moving the robotic arm to above the fryer slot, waiting until the ticket has at least been cooking for its minimum cook time, and unsubmerging the basket from the fryer slot. After the sequence of behaviors has been computed/simulated, and the simulated system state updated, the method returns to step 236 for querying whether more cooking actions are required.

If the search depth is greater than 0 at step 404, however, the method proceeds to step 406.

Step 406 states to simulate finishing schedule with search depth zero (0) and calculate baseline lateness. In embodiments, for purposes of looking ahead and simulating one option versus another, the system state is copied, and a scheduler algorithm as described herein is applied onto the copied state with search depth 0, so that the behaviors chosen will be entirely heuristics driven. For example, in embodiments, setting the search depth to 0 has the effect of predicting the robot would only unsubmerge any currently-cooking tickets as soon as possible, and not perform any other behaviors. In this way, the baseline lateness represents the minimum achievable overcooking lateness given the current system state. A baseline or control lateness value (t_{c}) is computed based on this simulated behavior.

Step 408 states to query whether any basket with cooked food on the hanger needs to be returned to the user via the auto basket slot. If ‘yes’, the method proceeds to step 410.

Step 410 states to simulate moving the basket to an auto-basket slot immediately and calculates the resultant lateness using the procedure described herein.

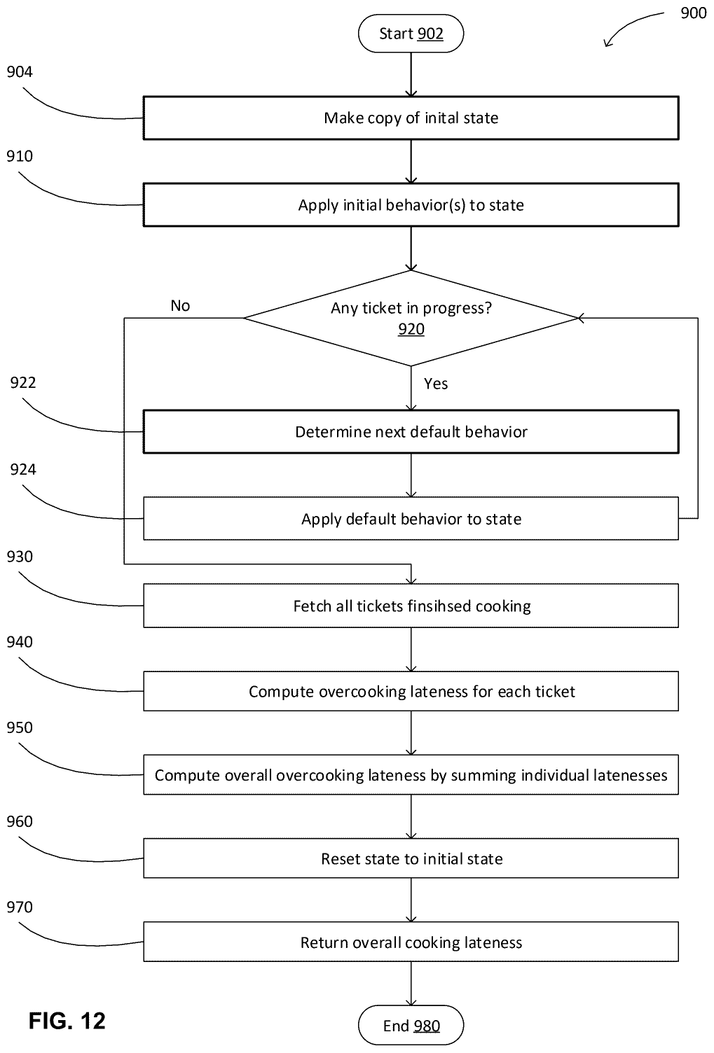

This step is performed by computing the time required to perform each simulated motion or behavior to immediately move the basket to the auto-basket slot. The output of step 410 is a simulated lateness having units of seconds or minutes. In preferred embodiments, as discussed further herein in connection with FIG. 12, the scheduler algorithm calculates the total overcooking cost (t1ₜₒₜₐₗ) by first computing the resultant predicted state after applying the optional behaviors (in this case, moving the basket with cooked food from hanger to auto-basket slot) and afterwards, all necessary default behaviors to finish cooking any in-progress tickets. From this resultant state, the lateness is calculated as the weighted sum of the individual ticket overcooking latenesses, each multiplied by that ticket's priority:

$$t {1}_{total} = {Σ}_{i = 1}^{n} {p}_{i} \times {t}_{i} ,$$

where n is the ticket number, t is the overcooking lateness time for each ticket number i, and p is priority assigned to each ticket number i.

Step 412 queries whether a next ticket is available to submerge from the dispenser according to the simulated system state. If ‘yes’, the method proceeds to step 414.

Step 414 states to simulate submerging ticket with varying delays and calculate best lateness (namely, the least total overcooking lateness). The output of step 414 is to identify a best or optimum delay, if any, to apply before submerging the basket of food. In embodiments of the invention, step 414 simulates a series of candidate delay times for submerging the ticket. In embodiments, candidate delay times (d) range from 0 to 20 seconds in, e.g., 4 or 5 second increments. For example, a five (5) second delay simulates picking up the ticket and submerging it after 5 seconds.

Total overcooking lateness is calculated for each delay simulation by computing the overcooking lateness of the ticket being submerged as well as the overcooking lateness of all other tickets in progress (if any) assuming default (typically unsubmerge behaviors) for all other tickets in progress. In embodiments, and as discussed further herein in connection with FIG. 12, the total overcooking lateness is a sum of the lateness of each ticket multiplied or weighted by a priority of the ticket:

$$t {2}_{total} = {Σ}_{i = 1}^{n} {p}_{i} \times {t}_{i} ,$$

where n is the ticket number, t is overcooking lateness time for each ticket number i, and p is priority assigned to each ticket number i.

If the candidate total overcooking lateness is greater than the baseline lateness, t_{c}, described above, then the delay is increased by an increment to the next time delay. The subprocess is repeated for all the varying candidate delays. The submerge behavior associated with the least total overcooking lateness (t2ₜₒₜₐₗ) is stored.

Step 416 queries whether an empty basket needs to be moved to a different slot, namely, from a hanger slot above the fryers to an autobasket drawer, or vice versa. If ‘yes’, the method proceeds to step 418.

Step 418 states to simulate moving the basket to a different slot immediately and calculating the overcooking lateness. This step is performed by computing the time required to perform each simulated motion or behavior to immediately move an empty basket to a more optimal slot. Generally, these movements are either to move an empty basket from the hanger to the autobasket drawers, or from the drawers to the hanger slot. This can be done for any number of reasons such as, without limitation, to improve balance of baskets per configuration heuristics; to make space in the autobasket drawers for another basket that needs to be returned there; to provide an empty basket to the user via the autobasket drawers to place more orders; and to remove a basket from the system that is not usable for processing orders from the dispenser (e.g., it has a lid, or a specialty insert).

In preferred embodiments, as discussed further herein in connection with FIG. 12, the scheduler algorithm calculates the total overcooking cost (t3ₜₒₜₐₗ) as the sum of the individual lateness for moving the basket to a hanger slot (or vice versa) and the individual latenesses of unsubmerging any in-progress tickets as soon as possible, and multiplying each individual lateness by the priority of the ticket:

$$t {3}_{total} = {Σ}_{i = 1}^{n} {p}_{i} \times {t}_{i} ,$$

where n is the ticket number, t is overcooking lateness time for each ticket number i, and p is priority assigned to each ticket number i.

Step 420 queries whether the lateness of moving a basket with cooked food is acceptable.

In embodiments, step 420 queries whether total overcooking cost (t1ₜₒₜₐₗ) as computed above is less than or equal to the baseline or control lateness time (t_{c}).

If ‘yes’, the method proceeds to step 422 which states to apply behaviors to pick up the cooked basket and update the simulated state accordingly.

However, if at step 420, the total overcooking cost (t1 total) is not less than or equal to the baseline or control lateness time (the), the method proceeds to step 430.

Step 430 queries whether lateness of submerging ticket is acceptable. In embodiments, step 430 queries whether total overcooking cost (t2ₜₒₜₐₗ) as computed above is less than or equal to the baseline or control lateness time (the).

If ‘yes’, the method proceeds to step 432 which states to apply behaviors to pick up the ticket, namely, to obtain the raw food from the dispenser or collect the basket with food from the autobasket drawers and apply simulated behaviors to submerge the raw food in a fryer slot, and update the simulated state accordingly.

However, if at step 430, the total overcooking cost (t2ₜₒₜₐₗ) is not less than or equal to the baseline or control lateness time (t_{c}), the method proceeds to step 440.

Step 440 queries whether the lateness of moving the empty basket is acceptable.

In embodiments, step 440 queries whether total overcooking cost (t3ₜₒₜₐₗ) as computed above is less than or equal to the baseline or control lateness time (t_{c}).

If ‘yes’, the method proceeds to step 442 which states to apply behaviors to pick up the empty basket and update the simulated state accordingly.

However, if at step 440, the total overcooking cost (t3ₜₒₜₐₗ) is not less than or equal to the baseline or control lateness time (t_{c}), the method proceeds to step 450.

Step 450 states to apply the earliest unsubmerge behavior. It is applied because none of the simulated options resulted in predicting less lateness than the baseline lateness. The default behaviors as described in step 406 are thus applied, and the simulated system state is updated accordingly.

Next, step 452 states to decrement the search depth. As discussed herein, the current search depth is stored and decreased after each predictor iteration in order to limit the number of potential branching paths of the state space tree to be explored. Thus, in embodiments, each time the planning module reaches a scenario where the predictor model is applied to compare two or more possible behavior options, the search depth will be decremented. Once the search depth or counter reaches 0, the scheduler only makes heuristic-based decisions and does not explore optional behaviors.

After step 452, with reference again to FIG. 5, the method returns to step 236 for querying whether any more cooking actions are required.

FIG. 8 is a flow chart of the empty basket planning module 500. In embodiments, per step 510, the simulated system state is evaluated for whether the basket in the gripper is empty.

If the basket in the robotic arm gripper is not empty, the method proceeds to the next phase 600, discussed herein.

However, if the robotic arm gripper basket is empty according to the simulated system state, the method proceeds to step 512.

Step 512 queries whether the search depth counter is greater than a threshold value. If the search depth is not greater than 0, the method proceeds to step 570.

Step 570 states to determine the best location to place the held basket. This determination is based on a heuristic set of rules. The best location for a basket can be based on many factors, including for example, the current balance of other baskets, need for an empty basket in the autobasket drawers, or need for empty spaces in the drawers for future baskets. In embodiments, the best location is typically either the closest available hanger slot to the robot arm's current simulated pose, or the closest available autobasket drawer slot to the robot arm's current simulated pose.

Step 580 states to apply behaviors to place the held basket. After all the behaviors to place the basket are simulated/computed, with reference again to FIG. 5, the method returns to step 236 for querying whether more cooking actions are required.

If, however, the search depth is greater than the threshold value at step 512, the method proceeds to step 520.

Step 520 states to simulate finishing schedule with search depth of zero (0) and calculate a baseline lateness. In embodiments, for purposes of looking ahead and simulating one option from another, the system state is copied, and a scheduler algorithm as described herein is applied onto the copied state with search depth 0, so that the behaviors chosen will be entirely heuristics driven. A baseline or control lateness value (the) is computed based on this simulated behavior.

Step 530 queries whether a next ticket is available to submerge from the dispenser according to the simulated system state. If ‘yes’, the method proceeds to step 532.

Step 532 states to simulate submerging ticket with varying delays and calculate best lateness. Lateness for submerging a ticket may be computed as described above in connection with step 414 of FIG. 7.

Step 540 queries whether the best computed overcooking lateness of the submerging ticket is acceptable. In embodiments, step 540 queries whether best total overcooking cost (tₜₒₜₐₗ) from step 532 is less than or equal to the baseline or control lateness time (t_{c}).

If ‘yes’, the method proceeds to step 542 which states to apply behaviors to pick up the ticket, namely, to obtain the raw food from the dispenser and apply simulated behaviors to submerge the raw food in a fryer slot and update the simulated state accordingly.

However, if at step 540, the best total overcooking cost (tₜₒₜₐₗ) is not less than or equal to the baseline or control lateness time (t_{c}), the method proceeds to step 550 which states to determine best location to place basket. The best location to place basket may be determined as described above in connection with step 570. The simulated behaviors are applied and the system state updated accordingly.

Step 560 states to decrement search depth, after which the method returns to step 236 for querying whether more cooking steps are required to be performed. In the embodiment shown in FIG. 5, step 236 states to query whether the search depth is greater than zero, a basket is in the gripper, or the basket is empty. As discussed herein, the search depth counter is maintained and decreased after each predictor iteration in order to limit the number of potential branching paths of the state space tree to be explored. Thus, in embodiments, each time the planning module reaches a scenario where the lookahead model is applied to compare two or more possible behavior options, the search depth will be decremented. Once the search depth or counter reaches a threshold value (e.g., search depth 0), the scheduler only makes heuristics-based decisions and does not explore optional behaviors.

FIG. 9 is a flow chart of the cooked food planning module 600. In embodiments, per step 610, the simulated system state is evaluated for whether the basket has cooked food.

If the basket does not have cooked food, the method proceeds to the next planning phase 700, discussed herein. However, if the basket does have cooked food according to the simulated system state, the method proceeds to step 620.

Step 620 queries whether to dump the held ticket, that is, to dump the basket of cooked food into the dump chute to return to the user. The decision is determined based on a set of heuristic rules and a set of preferences defined by the user. For embodiments, the user can assign one of three return strategy preferences per ticket: “always dump”, “always autobasket”, and “prefer autobasket”. If the preference for the ticket is “always dump”, the scheduling module will always decide to dump the ticket. If the preference is “always autobasket”, it will never decide to dump the food. If the preference is “prefer autobasket”, the scheduler will decide to dump the food only if there are no open autobasket drawers currently available to return the food. Certain mechanisms may exist to restrict the return strategy options available to the user. For example, in embodiments, if a basket of food has a lid, it must have the return strategy of “always autobasket”, as the lid would prohibit dumping food out of the basket.

If the answer at step 620 is ‘yes’, the method proceeds to step 630 which states to apply simulated behaviors to dump ticket, namely, dump the cooked food. In embodiments, step 630 would be performed by manipulating the basket of cooked food by the robotic arm to the chute (e.g., chute 92 shown in FIGS. 1, 3), and rotating the basket to dump the food from the basket onto the chute for delivery to the hot hold. Examples of steps for the dump ticket include, without limitation, moving the robot arm and held basket to the dump chute, and rotating the basket over the dump chute to release any food in the basket into the chute. In embodiments, this dumping motion may include optional shakes or oscillations of the basket to dislodge food stuck to the basket, with the number of shakes heuristically defined per food type or portion size. After the dump cooked food behaviors are simulated/computed, and the simulated system state updated, the method returns to step 236 for querying whether more cooking actions are required.

If, however, the basket of food is not dumped at step 620, the method proceeds to step 640 which queries whether there is an available auto basket slot (e.g., one of the drawers in auto-basket unit 50 as shown in FIG. 1, 2). If there is an available auto basket slot, the method proceeds to step 650 which states to apply simulated behaviors to place the basket in an auto basket slot. In embodiments, step 650 would be performed by manipulating the basket of cooked food by the robotic arm to the available slot, placing the basket in the slot, and releasing the basket. Examples of steps for placing the basket in the auto basket slot include, without limitation, moving the robot arm and held basket to the point above the autobasket drawers, and placing the basket into one of the open drawers. After the placing basket behaviors are performed, the method returns to step 236 for querying whether the search depth is greater than zero, a basket is in the gripper, or the basket is empty.

If an auto basket slot is not available at step 640, the method proceeds to step 660 which states to apply simulated behaviors to place the basket on a hanger slot (e.g., one of the hanger slots of the fryer module 40 as shown in FIG. 1). In embodiments, step 660 would be performed by manipulating the basket of cooked food by the robotic arm to the available hanger slot, placing the basket in the slot, and releasing the basket. Examples of steps for placing the basket on a hanger slot include, without limitation, moving the robot arm and held basket to the point above the selected hanger slot, and placing the basket onto the open hanger slot. After the placing basket behaviors are performed, the method returns to step 236 for querying whether the more cooking actions are required.

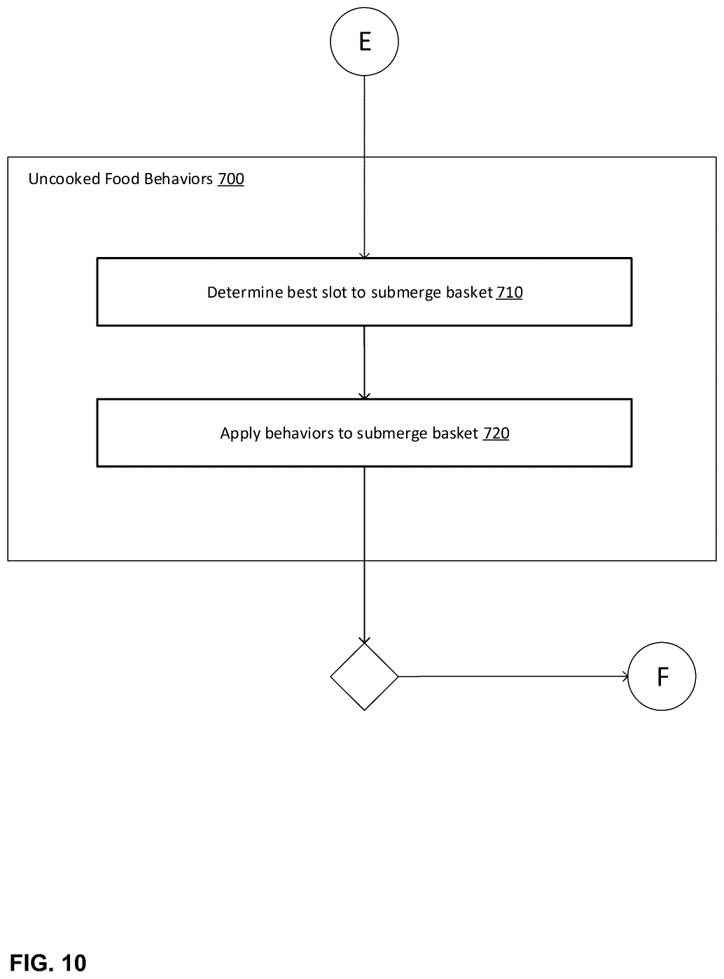

FIG. 10 is a flow chart corresponding to uncooked food behaviors planning module 700. In embodiments, the simulated system state is evaluated for whether there is a basket of uncooked food and if ‘yes’, the method proceeds to step 710 to determine the best slot to submerge the basket. In embodiments, the uncooked food planning module comprises a set of rules for determining the optimal slot to submerge the basket. Some slots may be in use or otherwise unavailable. Some slots may be designated for one type of food and excludes other types of foods. Certain food types may have preferences for certain slots, but allow cooking in other slots if the preferred fryer slots are already occupied or otherwise unavailable. In embodiments, the closest slot to the robot arm is selected among the set of slots with highest priority for a given food type.

Step 720 states to apply simulated behaviors to submerge the basket. In embodiments, a set of pre-determined behaviors or commands are simulated or computed according to a predetermined sequence to submerge the basket. For embodiments, the robotic arm may be programmed and operable to simulate moving the basket into the selected slot according to a predetermined script or route stored for the behavior. In embodiments, the robot moves over the selected fryer slot, and drops off the basket in the fryer slot after a number of agitations dictated by the menu configuration. After all the uncooked food actions have been computed, and the simulated system state updated, the method returns to step 236 for querying whether there are more cooking steps required, and in the embodiment shown in FIG. 5, whether the search depth is greater than zero, a basket is in the gripper, or the basket is empty.

With reference again to FIG. 5, in embodiments, the entire cooking planning phase 240 is continuously repeated until at step 236 there are no more cooking steps required, and in particular, the search depth counter reaches a threshold value (e.g., 0), the gripper is not holding a basket, or no baskets are cooking (namely, submerged) at which point the method proceeds to the clean-up planning phase 268. As described herein, the clean up phase 268 comprises generating an updated schedule.

FIG. 12 is a flow chart of a method to compute a predicted lateness for various optional robot behaviors and the default behavior, according to embodiments of the invention.

902 is the start of the process.

Step 904 states to make a copy of the initial state; that is, to make a copy of the state that has been generated thus far by the scheduler algorithm.

Step 910 states apply the initial behavior(s) to the state. The initial behaviors are the behaviors that we wish to evaluate to determine their resultant overcooking lateness. For example, if this procedure is evaluating the optional behaviors of submerging a new ticket, the initial behaviors would be moving to the basket's location in the autobasket drawers, picking up the basket, moving the robot above the chosen fryer slot, and submerging the basket into that slot.

Step 920 queries whether any ticket is in progress. A ticket is determined to be in-progress if the robot has taken actions to begin cooking the ticket, but the final cooked product has not yet been returned to the user.

If yes, the process advances to step 922 and step 924 which state, respectively, to determine the next default behavior and to apply it to the system state.

Steps 922 and 924 are repeated for each ticket in progress until there are no more tickets in progress at which point the process advances to step 930.

Step 930 states to fetch all tickets finished cooking, or stated alternatively, to query all tickets that were cooked by the procedure of steps 910-924.

Step 940 states to compute overcooking lateness for each ticket. In embodiments, the lateness of each ticket is computed based on the simulated historical state behavior data from steps 910-924 above.

Step 950 states to compute overall overcooking lateness by summing individual latenesses. In preferred embodiments, a predictor model calculates the total overcooking cost as the sum of the overcooking time of each finished ticket, and optionally wherein each individual lateness is multiplied by a priority of the ticket.

Step 960 states to reset state to the initial state. In embodiments, the simulated or copy of the state is reset to the initial state prior to the simulated behaviors by this procedure.

Step 970 states to return total overcooking lateness. This step is performed by the predictor model by sending the total overcooking lateness for the option being evaluated to the scheduler for comparing to the default or control lateness as described above.

Step 980 is end.

### Hardware Block Diagram

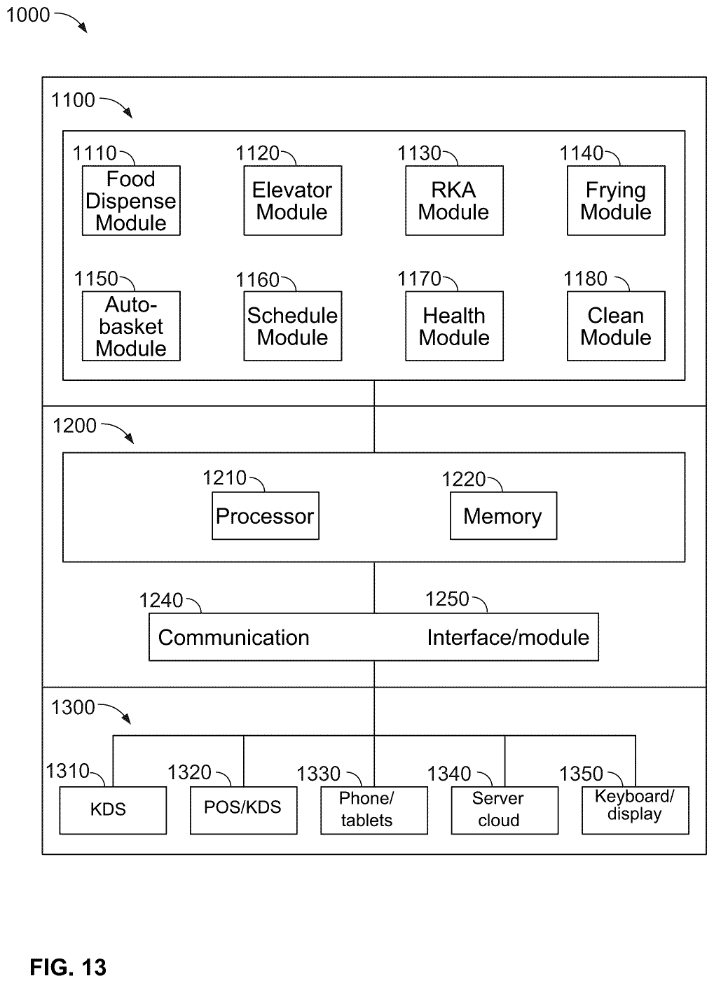

With reference to FIG. 13, a block diagram of a robotic food preparation system 1000 includes a plurality of functional modules 1100, computer and electronics 1200, and one or more inputs 1300.

Examples of functional modules 1100 include: raw food dispense module 1110, elevator module 1120, fryer module 1140, robotic arm module 1130, auto-basket module 1150, schedule module 1160, state manager module 1170, UI adapter module 1180, clean module (not shown), health/healing module (not shown), and logger (not shown).

In embodiments, the state manager 1170 is operable to aggregate all sensor/agent/user data to track the current state of the system. It processes all inputs that change the state of the system. For example, when a ticket is created, the state manager creates a state message for the ticket. When the basket is detected in a slot, the state manager creates an updated state message containing the new information for that basket, slot, and ticket. The state manager publishes the updated state message for other nodes (or modules) to use.

The scheduler module 1160 is programmed and operable to consume state messages and continuously generate/publish the schedule based on the latest state as described above.

The agent managers/executors (e.g., modules 1110, 1120, 1130, 1140, and 1150) are programmed and operable to consume schedules to execute the behaviors for its agent. It can report behavior start/end and key events to the state manager.

In embodiments of the invention, a module can include or have its own dedicated hardware and electronics including, e.g., a dedicated controller, motor or actuator, heat exchanger, processor, memory, PCB, integrated chip, and one or more sensors. For embodiments, as described herein, the robotic arm and gripper include internal sensors for measuring current, position, and torque on the arm and gripper. For embodiments, the elevator module includes sensors for measuring current supplied to the elevator motor. For embodiments, the dispenser module includes a scale to measure food delivered from the dispenser.

Optionally, one or more of the modules are self-contained functional units or stations that are conveniently coupled to the computing system 1200. For example, in embodiments of the invention, the refrigerated hopper/dispenser 20 and fryer station 40 are self-contained units that are conveniently arranged with the frame 11, and connected electronically to the computer 1200 to control the method steps as described above.

The UI Adapter 1180 is operable to consume state messages and schedules, and output a “UI State” message that is used to drive the user interface. In embodiments, the UI state can also include predicted timings of tickets and other values that can be predicted based on the latest schedule.

The logger (not shown) is operable to log key data from most messages to a database, optionally a remote or cloud server database.

The computing device 1200 can be a conventional micro-computer and the like including, for example, one or more processors 1210 and memory or storage devices 1220 operable with the system state to keep track of all events, status, and steps occurring during operation, and communication interface 1240. However, the computing device may vary widely and include additional processors, types of memory, ports, communication interfaces (e.g., Wi-Fi, Bluetooth, ethernet, etc.), power supplies, and other components. The computing device 1200 can be internal to (or remote from) the food preparation system.

The computing device 1200 can be responsive to signals, instructions or requests from a number of input devices 1300. Examples of input devices include, without limitation, sensors 1310, kitchen display (KDS)/POS system 1320, tablets and smart phone 1330, and onboard touch screens displays 1350. Instructions or requests can be entered by an operator, team member, customer, or another as the case may be.

In embodiments, with reference to FIGS. 1-3, the computing and electronics can be arranged in an enclosure 80 towards the rear of the system 10, behind the dispenser station 20, and outside of the framed robotic workspace. In embodiments, the computer and electronics is conveniently accessed by rolling the dispenser unit 20 out of the way.

FIG. 13 also shows server 1340 which can be remote or cloud-based. Such remote servers 1340 can be used to generally communicate with the system, receive and store data, upload program updates, and host an associated website. Input devices (e.g., without limitation, tablets, smart phones, desktop or workstations) may communicate through a web browser or download a program or App to conveniently communicate with the website to place an order and monitor activity.

Additionally, a wide variety of sensors can be incorporated with or otherwise used with each of the modules.

For example, a limit switch can sense when the elevator basin is at a first position. The system can be programmed to prohibit the hopper from dispensing food when the limit switch is not in the first position. An example of a suitable limit switch is model XVM3SBQF1802L03, manufactured by CIT Relay and Switch (Rogers, MN).

Photo-presence sensors can be used to monitor whether an object is present. For example, should the fry basket not be detected, the method proceeds to stop operation until it is replaced. An example of a suitable photo-presence sensor is model WL15-A2430, manufactured by SICK AG, (Waldkirch, Germany).

Load sensors can be used to detect weight. Based on the detected weight, the system can compute whether the proper amount of food has been dispensed into the elevator basin. An example of a suitable load cell is model LCEB, manufactured by Omega Engineering Inc. (Norwalk, CT).

Break beam sensors/reflectors can monitor for a break in the beam. For example, the break beam sensor can monitor if the elevator or auto-baskets are in the first position. An example of a suitable break beam sensor and reflector is model O6S202-O6S-OOKG/AS/3P, manufactured by ifm Efector, Inc. (Malvern, PA 19355).

In embodiments, a safety light curtain for monitoring the ingress window of the auto-drawer is based on use of break beam sensors.

Proximity sensor(s) can monitor for position of the components. For example, one or more proximity sensors may be used to detect the position of the elevator. An example of a suitable proximity sensor is model DW-AD-504-M5, manufactured by Contrinex Gmbh. (Corminboeuf, Switzerland).

In embodiments of the invention, cameras are added and aimed at one or more of the stations. Examples of cameras include RGB and IR cameras. The camera images are sent to the computer processors for determining food item recognition, localization, tracking, food aggregation/clumping, and food doneness. Computer modules for use with the cameras and sensors are described in US Patent Publication No. 20210022559, filed Jul. 25, 2020, entitled “TRANSPORTABLE ROBOTIC-AUTOMATED KITCHEN WORKCELL”, U.S. Pat. No. 10,919,144, filed Aug. 10, 2018, entitled “MULTI-SENSOR ARRAY INCLUDING AN IR CAMERA AS PART OF AN AUTOMATED KITCHEN ASSISTANT SYSTEM FOR RECOGNIZING AND PREPARING FOOD AND RELATED METHODS”, and US Patent Publication No. 20220386807, filed Jun. 1, 2022, entitled “AUTOMATED KITCHEN SYSTEM FOR ASSISTING HUMAN WORKER PREPARE FOOD”, each of which is incorporated herein by reference in its entirety.

### ALTERNATIVE EMBODIMENTS

The invention is intended to include a wide variety of embodiments.

For example, it is to be understood the functional modules may be arranged differently than that shown; some functional units may be removed; and additional functional units (whether serving the same or different purpose) may be added to the system to increase throughput or types of food offerings as desired.

1. An automated food preparation system for cooking raw food comprising:
an enclosure defining a robot workspace;
a robotic arm and gripper arranged within the robot workspace;
a plurality of functional stations comprising:
a dispensing station for dispensing raw food into a basin within the enclosure;
a food transfer station comprising the basin and arranged within the enclosure to receive the raw food from the dispensing station, and operable to lift the basin, and to transfer the raw food from the basin to a fry basket held by the gripper of the robotic arm;
a fry station arranged within the enclosure and comprising at least one fryer slot for submerging a fry basket of raw food, and at least one unsubmerged hanger slot; and
a computer comprising:
a state manager module for maintaining the system state;
a scheduling module programmed and operable to:
receive one or more orders for cooked food;
compute a schedule to control actions of the plurality of functional stations to transfer the raw food to the fry basket, move the fry basket into a fryer slot and fry the raw food, move the fry basket into a hanger slot, dump the cooked food to an egress area for transferring the cooked food from inside the enclosure to outside the enclosure;
send the schedule to each of the plurality of functional stations for execution; and
wherein the scheduling module computes the schedule based on applying a set predetermined heuristic rules and, where more than one option exists for determining an action, the scheduling module applies a predictor model to predict a cost for each option, and selects an optimal option corresponding to reducing the cost; and
converting a simulated system state event history into the schedule.

2. The system of claim 1, wherein the cost is overcooking lateness.

3. The system of claim 2, wherein the cost is a weighted sum of overcooking lateness for multiple individual orders.

4. The system of claim 1, wherein the predetermined heuristic rules are applied for scheduling actions comprising: transferring raw food to the fry basket from the elevator basin, actions for a basket of cooked food, and actions for a basket of uncooked food.

5. The system of claim 1, wherein the predictor model comprises the following steps:
computing overcooking lateness for a set of predetermined default actions (t_{c});
computing overcooking lateness for each alternative option (t1, t2, t3, . . . tn); and
selecting for the schedule a behavior or sequence of behaviors from the set of predetermined default actions or the alternative option having the least overcooking lateness.

6. The system of claim 5, wherein the predictor model is applied when the system state comprises at least one of: robot arm gripper has an empty basket; and when the robot arm gripper is not holding a basket.

7. The system of claim 6, wherein the predictor model is only applied when the system state comprises: robot arm gripper has an empty basket; and when the robot arm gripper is not holding a basket.

8. The system of claim 1, further comprising an auto-drawer station arranged within the enclosure comprising at least one drawer movable from a retracted first configuration within the enclosure to an extended second configuration through an ingress window outside of the enclosure, and wherein the at least one drawer and ingress window are arranged, sized and operable to transfer a fry basket between a human outside of the enclosure and the robotic arm inside of the enclosure without the human or robotic arm penetrating a boundary defined by the enclosure, and optionally, further comprising a light curtain or another safety system to detect when the drawer is in the second configuration or when the ingress window is penetrated by an object.

9. The system of claim 8, further comprising at least one camera arranged to obtain image data of any contents in the fry basket in the retracted configuration.

10. The system of claim 9, wherein the computer system is further programmed and operable to detect and classify a food item based on the image data, and wherein the computer system is programmed and operable to generate an order based on the food item classified from the perception module.

11. A method for automatically cooking raw food comprising:
receiving one or more orders;
computing a schedule to control actions of a plurality of functional stations to transfer the raw food to a fry basket, move the fry basket into a fryer slot and fry the raw food, move the fry basket into a hanger slot, dump the cooked food to an egress area;
sending the schedule to each of the plurality of functional stations for execution; and
wherein the computing a schedule comprises:
applying a set of predetermined heuristic rules;
determining whether more than one option exists based on a simulated system state, and where more than one option exists, predicting a cost for each option, and selecting an optimal option corresponding to reducing the cost; and
converting a simulated system state event history into the schedule.

12. The method of claim 11, wherein the cost is overcooking lateness.

13. The method of claim 12, wherein the cost is a weighted sum of overcooking lateness for multiple individual orders.

14. The method of claim 11, wherein the predetermined heuristic rules are applied for scheduling actions comprising: transferring raw food to the fry basket from the elevator basin, actions for a basket of cooked food, and actions for a basket of uncooked food.

15. The method of claim 11, wherein the predicting comprises the following steps:
computing overcooking lateness for a set of predetermined default actions (t_{c});
computing overcooking lateness for each alternative option (t1, t2, t3, . . . tn).

16. The method of claim 15, wherein the selecting comprises selecting the set of predetermined default actions or the alternative option having the least overcooking lateness.

17. The method of claim 16, wherein the predicting is applied when the system state comprises at least one of: robot arm gripper has an empty basket; and when the robot arm gripper is not holding a basket.

18. The method of claim 17, wherein the predicting is only applied when the system state comprises: robot arm gripper has an empty basket; and when the robot arm gripper is not holding a basket.

19. The method of claim 11, further comprising:
obtaining image data of any contents in the fry basket in a drawer of an auto-drawer station when the drawer is in a retracted configuration;
detecting and classifying a food item in the drawer based on the image data; and
generating an order based on the classified food item.

20. A method for automatically cooking raw food comprising:
receiving one or more orders;
updating the actual system state based on the received orders;
computing a schedule to control actions of a plurality of functional stations;
sending the schedule to each of the plurality of functional stations for execution; and
wherein the computing the schedule comprises:
creating a simulated system state;
determining whether more than one option exists based on the simulated system state, and where more than one option exists, predicting a cost for each option, and selecting an optimal option corresponding to reducing the cost;
updating the simulated system state based on the optimal option;
converting a simulated system state event history into the schedule.
